(19) United States
(12) Patent Application Publication
(10) Pub. No.: US 2013/0247069 A1
(43) Pub. Date: Sep. 19, 2013

(54) Creating A Checkpoint Of A Parallel Application Executing In A Parallel Computer That Supports Computer Hardware Accelerated Barrier Operations

(71) Applicants: Wen Chen, Shanghai (CN); Tsai-Yang Jea, Poughkeepsie, NY (US); William P. Lepera, Poughkeepsie, NY (US); Serban C. Maerean, Ridgefield, CT (US); Hung Q. Thai, Bronx, NY (US); Hanhong Xue, Wappingers Falls, NY (US); Zhi Zhang, Poughkeepsie, NY (US)

(72) Inventors: Wen Chen, Shanghai (CN); Tsai-Yang Jea, Poughkeepsie, NY (US); William P. Lepera, Poughkeepsie, NY (US); Serban C. Maerean, Ridgefield, CT (US); Hung Q. Thai, Bronx, NY (US); Hanhong Xue, Wappingers Falls, NY (US); Zhi Zhang, Poughkeepsie, NY (US)

(73) Assignee: INTERNATIONAL BUSINESS MACHINES CORPORATION, ARMONK, NY (US)

(21) Appl. No.: 13/420,676

(22) Filed: Mar. 15, 2012

(51) Int. Cl. G06F 9/46

(52) U.S. Cl. 718/107

(57) ABSTRACT

In a parallel computer executing a parallel application, where the parallel computer includes a number of compute nodes, with each compute node including one or more computer processors, the parallel application including a number of processes, and one or more of the processes executing a barrier operation, creating a checkpoint of a parallel application includes: maintaining, by each computer processor, global barrier operation state information, the global barrier operation state information includes an aggregation of each process's barrier operation state information; invoking, for each process of the parallel application, a checkpoint handler; saving, by each process's checkpoint handler as part of a checkpoint for the parallel application, the process's barrier operation state information; and exiting, by each process, the checkpoint handler.

### STATEMENT REGARDING FEDERALLY SPONSORED RESEARCH OR DEVELOPMENT

This invention was made with Government support under Contract No. HR0011-07-9-0002 awarded by the Department of Defense. The Government has certain rights in this invention.

### BACKGROUND OF THE INVENTION

1. Field of the Invention

The field of the invention is data processing, or, more specifically, methods, apparatus, and products for creating a checkpoint of a parallel application executing in a parallel computer.

2. Description of Related Art

From time to time and for various reasons, a checkpoint of an executing parallel application may be desired. As of today, checkpoints of parallel applications are either incomplete or inefficient due, at least in part, to difficulty in fully capturing a checkpoint of the application while the processes of the application are engaged in a barrier operation.

### SUMMARY OF THE INVENTION

Methods, parallel computers, and computer program products for creating a checkpoint of a parallel application executing in a parallel computer are disclosed in this specification. The parallel computer includes a plurality of compute nodes with each compute node including one or more computer processors. The parallel application includes a plurality of processes with one or more of the processes executing a barrier operation. In embodiments of the present invention, creating a checkpoint of a parallel application includes: maintaining, by each computer processor, global barrier operation state information, where the global barrier operation state information includes an aggregation of each process's barrier operation state information; invoking, for each process of the parallel application, a checkpoint handler; saving, by each process's checkpoint handler as part of a checkpoint for the parallel application, the process's barrier operation state information; and exiting, by each process, the checkpoint handler.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system for creating a checkpoint of a parallel application executing in a parallel computer according to embodiments of the present invention.

FIG. 2 sets forth a flow chart illustrating an exemplary method for creating a checkpoint of a parallel application executing in a parallel computer according to embodiments of the present invention.

FIG. 3 sets forth a flow chart illustrating a further exemplary method for creating a checkpoint of a parallel application executing in a parallel computer according to embodiments of the present invention.

FIG. 4 sets forth a flow chart illustrating a further exemplary method for creating a checkpoint of a parallel application executing in a parallel computer according to embodiments of the present invention.

FIG. 5 sets forth a flow chart illustrating a further exemplary method for creating a checkpoint of a parallel application executing in a parallel computer according to embodiments of the present invention.

### DETAILED DESCRIPTION OF EXEMPLARY EMBODIMENTS

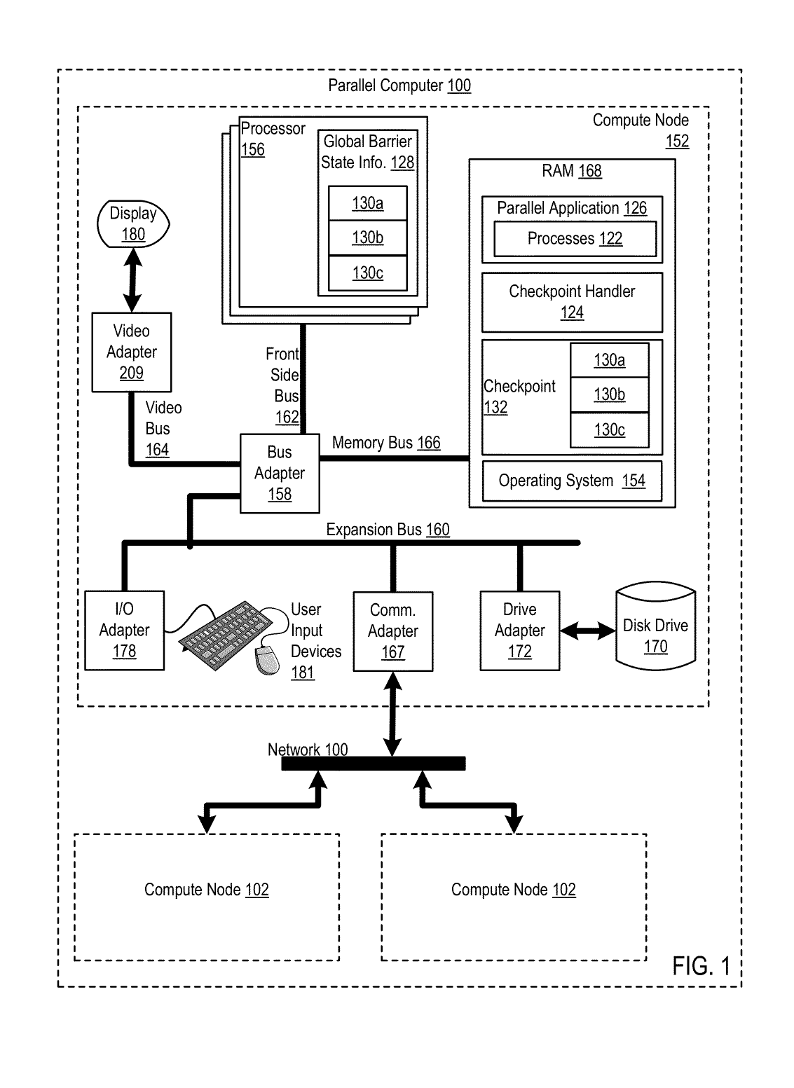

Exemplary methods, apparatus, and products for creating a checkpoint of a parallel application executing in a parallel computer in accordance with embodiments of the present invention are described with reference to the accompanying drawings, beginning with FIG. 1. FIG. 1 sets forth a block diagram of an example system for creating a checkpoint of a parallel application executing in a parallel computer according to embodiments of the present invention. A checkpoint generally refers to one or more data structures containing a ‘snapshot’ of the current state of an executing application. Once created, the application may be restarted, based on the checkpoint, in exactly the sate the application was in at the time the checkpoint was created. In this way, checkpoints are often used for testing, periodic backups, error recovery, failover, migration, and the like.

The system of FIG. 1 includes a parallel computer (100) configured to create a checkpoint of a parallel application executing in the parallel computer. The parallel computer (100) of FIG. 1 includes a plurality of compute nodes (102, 152). Each compute node (102, 152) in the example of FIG. 1 is an example of automated computing machinery, that is, a computer. One compute node (152) in the example of FIG. 1 is depicted with several components and software modules, described below in greater detail, but readers of skill in the art will recognize that each compute node (102) may also include the same or similar components and the same or similar software modules all of which may operate as described below with respect to the components of the example compute node (152).

The compute node (152) of FIG. 1 includes at least one computer processor (156) or ‘CPU’ as well as random access memory (168) (RAM') which is connected through a high speed memory bus (166) and bus adapter (158) to the processor (156) and to other components of the compute node (152). Stored in RAM (168) is a parallel application (126), a module of computer program instructions that is executed in a number of parallel processes (122). Such an application may carry out various data processing tasks, utilizing parallelism to increase efficiency of the data processing.

The processors (156) of the compute node (152) provide support for barrier operations carried out by processes (122) of the parallel application (126). In the example of FIG. 1, each processor maintains global barrier operation state information (128) (referred to hereinafter as ‘global state information’) describing the state of each process participating in the global barrier operation. That is, the global state information includes an aggregation of each process's barrier operation state information (130a, 130b, 130c). In the example of FIG. 1, state information (130a, 130b, 130c) for three separate processes is depicted for clarity of explanation. Readers will recognize that any number of processes may participate in a barrier operation and as such, the global state information (128) may contain any number of process-specific state information entries.

The global state information (128) is ‘global’ in that the each processor stores the same information through modification propagation. In some embodiments, the scope of the global state information is compute node-specific. That is, each processor in a compute node includes the same global state information. In other embodiments, the scope of the global state information may be much greater; including a group of compute nodes or even the parallel computer as a whole. When executing a barrier operation, each process updates the process's state information in the processor's global state information (128). In some embodiments, the process updates the process's state information in the processor upon which the process is executing without making the same change to other processors upon which the process is not executing. The processor receiving such change propagates the change throughout the processors (156) such that when propagation of the change is complete, all processors store the same global state information (128).

The global state information (128) may be implemented in various ways. In some embodiments, each processor (156) may maintain a hardware register designated for storing the global barrier operation state information (128), where each byte of the register is associated with a separate process and represents that process's barrier operation state information. When executing a barrier operation, each process (122) may be configured to update the value in the byte associated with the process to indicate entry into the barrier. The Power 6™ and Power 7™ processors from IBM™, for example, employ a barrier synchronization register (‘BSR’) that includes one byte for each process in a barrier operation.

In the example of FIG. 1, the processes (122) of the parallel application (126) are executing a barrier operation. During execution of the barrier operation, each process (122) of the parallel application (126) invokes a checkpoint handler (124). A checkpoint handler (124) as the term is used in this specification refers to a module of computer program instructions that, when executed, causes the parallel computer (100) to operate for creating a checkpoint (124) of the parallel application (124) executing in the parallel computer (100) in accordance with embodiments of the present invention. Invoking a checkpoint handler may be carried out in various ways. A checkpoint handler may be invoked responsive to a user request, responsive to an interrupt provided periodically by the operating system (154) or another module, responsive to a detection of an error in execution of the parallel application (126), and so on as will occur to readers of skill in the art.

Each separate process invokes a separate checkpoint handler (124). That is, for every process in the parallel application, a separate checkpoint handler (124) is invoked and the checkpoint handler (124)s operate in parallel with one another. Once invoked, the checkpoint handler (124) of each process saves, as part of a checkpoint (132) for the parallel application, the process's barrier operation state information (130a, 130b, 130c) and exits. Readers of skill in the art will recognize that other information, in addition to each process's barrier operation state information, may also be stored as part of the checkpoint. As a result of each process's checkpoint handler (124) storing that process's barrier operation state information, the exact barrier state information from the perspective of each process is captured at the time of checkpoint. In this way, if checkpoint creation occurs before propagation of a process's barrier operation state information amongst the processors (156) is complete, the checkpoint (132) reflects the accurate value of that process's barrier operation state information. Consider, for example, that a first process updates the process's global barrier operation state information in one processor, propagation begins, and, before the update is propagated amongst all processors, checkpoint creation is initiated. In this example, at the time of checkpoint creation, at least one processor contains a different version of the global state information (128) than other processors. When the checkpoint handler (124) for the first process saves that first process's barrier operation state information as part of the checkpoint, however, the checkpoint will include the correct state information.

Once the checkpoint is created, the parallel application may operate in a variety of ways. In some embodiments, for example, upon completion checkpoint creation and exiting the checkpoint handler, the parallel application may continue executing. In some embodiments, the parallel application may exit and immediately restart in dependence upon the checkpoint. In some embodiments, the parallel application may exit upon checkpoint creation, a second and different parallel application may be executed, and upon completion of the second parallel application, the checkpoint may be utilized to restart the previously exited parallel application.

Also stored in RAM (168) is an operating system (154). Operating systems useful in parallel computers configured for creating a checkpoint of a parallel application according to embodiments of the present invention include UNIX™, Linux™, Microsoft Windows XP™, Microsoft Windows 7™, AIX™, IBM's i5/OS™, and others as will occur to those of skill in the art. The operating system (154), parallel application (126), checkpoint handler (124), and checkpoint (132) in the example of FIG. 1 are shown in RAM (168), but many components of such software typically are stored in non-volatile memory also, such as, for example, on a disk drive (170).

The compute node (152) of FIG. 1 includes disk drive adapter (172) coupled through expansion bus (160) and bus adapter (158) to processor (156) and other components of the compute node (152). Disk drive adapter (172) connects non-volatile data storage to the compute node (152) in the form of disk drive (170). Disk drive adapters useful in compute nodes configured for creating a checkpoint of a parallel application executing in a parallel computer according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example compute node (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example compute node (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary compute node (152) of FIG. 1 includes a communications adapter (167) for data communications with other compute nodes (102) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for creating a checkpoint of a parallel application executing in a parallel computer according to embodiments of the present invention include modems for wired dial-up communications, Ethernet (IEEE 802.3) adapters for wired data communications network communications, and 802.11 adapters for wireless data communications.

The arrangement of compute nodes, networks, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

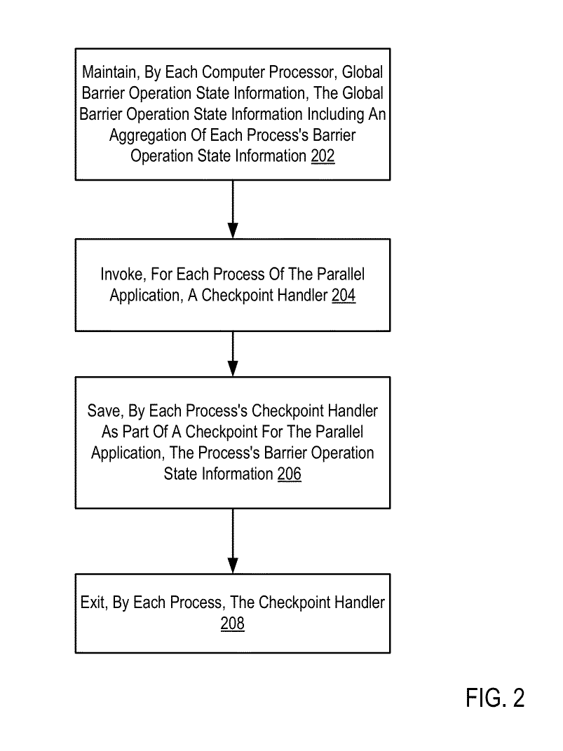

For further explanation, FIG. 2 sets forth a flow chart illustrating an exemplary method for creating a checkpoint of a parallel application executing in a parallel computer according to embodiments of the present invention. The method of FIG. 2 is carried out in a parallel computer similar to the parallel computer (100) depicted in the example of FIG. 1. Such a parallel computer includes a plurality of compute nodes, with each compute node including one or more computer processors. The parallel computer executes a parallel application. The parallel application includes a plurality of processes where one or more of the processes is executing a barrier operation.

The method of FIG. 2 includes maintaining (202), by each computer processor, global barrier operation state information. In the example of FIG. 2, the global barrier operation state information includes an aggregation of each process's barrier operation state information. Maintaining (202) global barrier operation state information may be carried out in various ways including, for example, storing an initial value for each process, receiving, from time to time, a change to the value of a process; and for each change, propagating the change amongst other processors. In some embodiments, the change is propagated amongst other processors within the same compute node, while in other embodiments the change is propagated amongst processors in other compute nodes as well.

The method of FIG. 2 also includes invoking (204), for each process of the parallel application, a checkpoint handler. Invoking (204) a checkpoint handler may be carried out in various ways. For example, invoking (204) a checkpoint handler may be carried out through an hardware or software interrupt, by a periodic function call, responsive to a user request, and in other ways as will occur to readers of skill in the art.

The method of FIG. 2 also includes saving (206), by each process's checkpoint handler as part of a checkpoint for the parallel application, the process's barrier operation state information. Saving (206), by each process's checkpoint handler as part of a checkpoint for the parallel application, the process's barrier operation state information may be carried out in various ways including, for example, by saving the process's barrier operation state information in an element of a data structure stored at a predefined memory location known to each checkpoint handler.

The method of FIG. 2 also includes exiting (208), by each process, the checkpoint handler. Exiting (208) the checkpoint handler may be carried out in various ways including, for example, by returning to execution of the parallel application, by exiting the parallel application, and in other ways as will occur to readers of skill in the art.

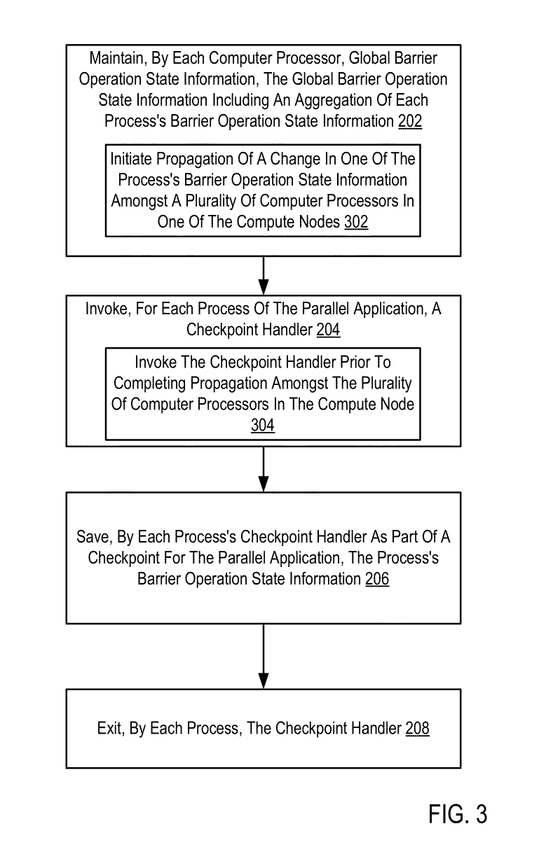

For further explanation, FIG. 3 sets forth a flow chart illustrating a further exemplary method for creating a checkpoint of a parallel application executing in a parallel computer according to embodiments of the present invention. The method of FIG. 3 is similar to the method of FIG. 2 in that the method of FIG. 3 is also carried out in a parallel computer similar to the parallel computer (100) depicted in the example of FIG. 1. Such a parallel computer includes a plurality of compute nodes, with each compute node including one or more computer processors. The parallel computer executes a parallel application. The parallel application includes a plurality of processes where one or more of the processes is executing a barrier operation.

The method of FIG. 3 is also similar to the method of FIG. 2 in that the method of FIG. 3 includes: maintaining (202) global barrier operation state information; invoking (204) a checkpoint handler for each process; saving (206) the process's barrier operation state information as part of a checkpoint; and exiting (208) the checkpoint handler. The method of FIG. 3 differs from the method of FIG. 2, however, in that in the method of FIG. 3, maintaining (202) global barrier operation state information includes initiating (302) propagation of a change in one of the process's barrier operation state information amongst a plurality of computer processors in one of the compute nodes. Initiating (302) propagation of a state information change amongst a plurality of computer processors in one of the compute nodes may be carried out in various ways including, for example, by broadcasting an update command, the updated value, and an identifier of the process along an inter-processor data communications bus coupling the processors to one another for data communications. In embodiments in which the global barrier state information is implemented as a hardware register of each processor, for example, a change may be propagated amongst processors by setting in the other processors a predefined flag (e.g. changing the value of a predefined bit) designated to indicate a change of a value in the register, and latching an register index (e.g. an offset) along with the value into the register.

Also in the method of FIG. 3, invoking (204) the checkpoint handler includes invoking (204) the checkpoint handler prior to completing propagation amongst the plurality of computer processors in the compute node. That is, in some embodiments, the checkpoint handler may be invoked—and checkpoint creation may begin—prior to complete propagation of a change in a process's barrier operation state information. Because each process, through that process's checkpoint handler, separately saves (206) its own current and accurate barrier operation state information as part of the checkpoint however, an interruption of the propagation of a change in such state information does not affect the accuracy of the created checkpoint.

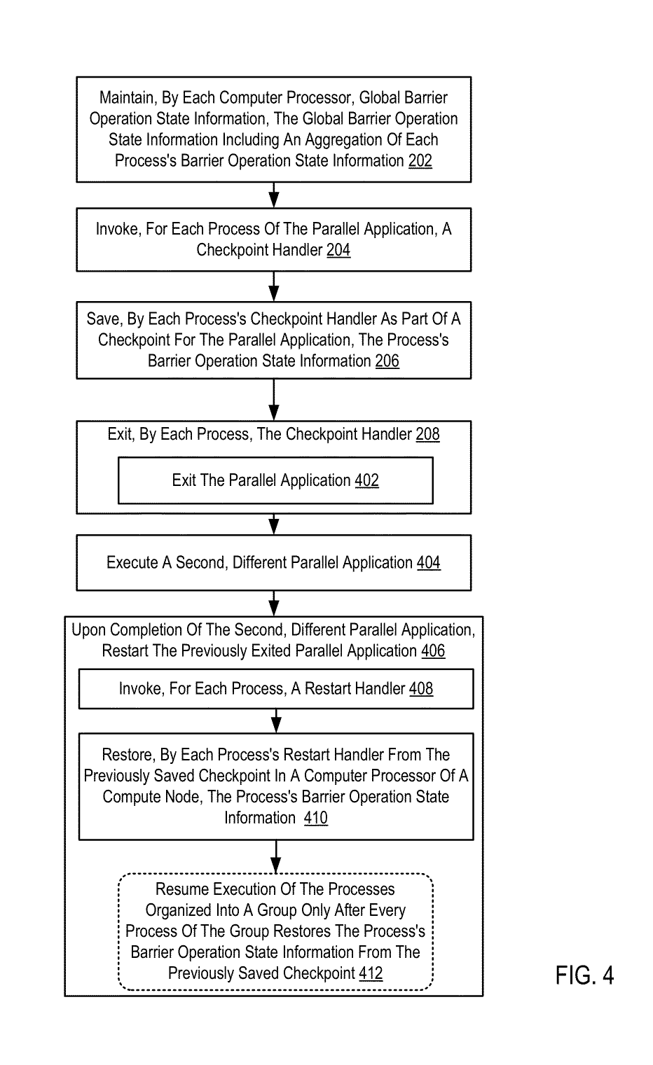

For further explanation, FIG. 4 sets forth a flow chart illustrating a further exemplary method for creating a checkpoint of a parallel application executing in a parallel computer according to embodiments of the present invention. The method of FIG. 4 is similar to the method of FIG. 2 in that the method of FIG. 4 is also carried out in a parallel computer similar to the parallel computer (100) depicted in the example of FIG. 1. Such a parallel computer includes a plurality of compute nodes, with each compute node including one or more computer processors. The parallel computer executes a parallel application. The parallel application includes a plurality of processes where one or more of the processes is executing a barrier operation.

The method of FIG. 4 is also similar to the method of FIG. 2 in that the method of FIG. 4 includes: maintaining (202) global barrier operation state information; invoking (204) a checkpoint handler for each process; saving (206) the process's barrier operation state information as part of a checkpoint; and exiting (208) the checkpoint handler. The method of FIG. 4 differs from the method of FIG. 2, however, in that in the method of FIG. 4, exiting (208) the checkpoint handler includes exiting (402) the parallel application.

The method of FIG. 4 also includes executing (404) a second, different parallel application and, upon completion of the second, different parallel application, restarting (406) the previously exited parallel application. In the method of FIG. 4, restarting (406) the previously exited parallel application is carried out by invoking (408), for each process, a restart handler and restoring (410), by each process's restart handler from the previously saved checkpoint in a computer processor of a compute node, the process's barrier operation state information.

In some embodiment, a subset of the parallel applications' processes may be organized into a group. In such embodiments, restarting (412) the parallel application also includes resuming (412) execution of the processes organized into a group only after every process of the group restores the process's barrier operation state information from the previously saved checkpoint.

Although the method of FIG. 4 depicts embodiments in which a second application executes after the first application exits, readers of skill in the art will recognize that in some embodiments, no second application is executed. Instead, after exiting (402) the parallel application, the parallel application may be immediately or at some later time, restarted in the same manner as that depicted in FIG. 4: invoking (408) a restart handler for each process and restoring (410) each process's barrier operation state information from the previously saved checkpoint.

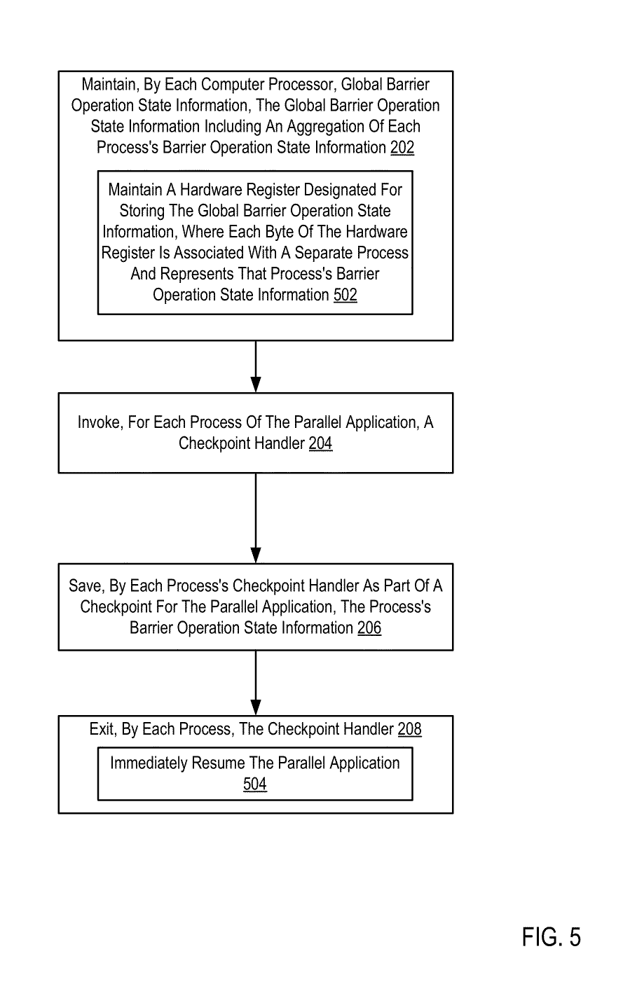

For further explanation, FIG. 5 sets forth a flow chart illustrating a further exemplary method for creating a checkpoint of a parallel application executing in a parallel computer according to embodiments of the present invention. The method of FIG. 5 is similar to the method of FIG. 2 in that the method of FIG. 5 is also carried out in a parallel computer similar to the parallel computer (100) depicted in the example of FIG. 1. Such a parallel computer includes a plurality of compute nodes, with each compute node including one or more computer processors. The parallel computer executes a parallel application. The parallel application includes a plurality of processes where one or more of the processes is executing a barrier operation.

The method of FIG. 5 is also similar to the method of FIG. 2 in that the method of FIG. 5 includes: maintaining (202) global barrier operation state information; invoking (204) a checkpoint handler for each process; saving (206) the process's barrier operation state information as part of a checkpoint; and exiting (208) the checkpoint handler. The method of FIG. 5 differs from the method of FIG. 2, however, in that in the method of FIG. 5, maintaining (202), by each computer processor, global barrier operation state information is carried out by maintaining (502) a hardware register designated for storing the global barrier operation state information. In such a hardware register, each byte of the register is associated with a separate process and represents that process's barrier operation state information. As explained above, example processors that include such a hardware register include IBM's™ Power 6™ and Power 7™ processors, where the register is called the barrier synchronization register.

Also in the method of FIG. 5, exiting (208) the checkpoint handler includes immediately resuming (504) the parallel application. Unlike the embodiments described above with respect to FIG. 4 in which the parallel application exits when the checkpoint handler exits, the method of FIG. 5 depicts an embodiment in which the parallel application immediately resumes execution upon exiting the checkpoint handler.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of creating a checkpoint of a parallel application executing in a parallel computer, the parallel computer comprising a plurality of compute nodes, each compute node comprising one or more computer processors, the parallel application comprising a plurality of processes, one or more of the processes executing a barrier operation, the method comprising:
maintaining, by each computer processor in computer processor hardware, global barrier operation state information, the global barrier operation state information comprising an aggregation of each process's barrier operation state information;
invoking, for each process of the parallel application, a checkpoint handler;
saving, by each process's checkpoint handler as part of a checkpoint for the parallel application, the process's barrier operation state information; and
exiting, by each process, the checkpoint handler.

2. The method of claim 1 wherein:
maintaining global barrier operation state information further comprises initiating propagation of a change in one of the process's barrier operation state information amongst a plurality of computer processors in one of the compute nodes; and
invoking the checkpoint handler further comprises invoking the checkpoint handler prior to completing propagation amongst the plurality of computer processors in the compute node.

3. The method of claim 1 wherein exiting the checkpoint handler further comprises exiting the parallel application, and the method further comprises:
executing a second, different parallel application; and
upon completion of the second, different parallel application, restarting the previously exited parallel application, including:
invoking, for each process, a restart handler; and
restoring, by each process's restart handler from the previously saved checkpoint in a computer processor of a compute node, the process's barrier operation state information.

4. The method of claim 1 wherein exiting the checkpoint handler further comprises exiting the parallel application, and the method further comprises:
restarting the previously exited parallel application, including:
invoking, for each process, a restart handler; and
restoring, by each process's restart handler from the previously saved checkpoint in a computer processor of a compute node, the process's barrier operation state information.

5. The method of claim 4 wherein
a subset of the parallel applications' processes are organized into a group; and restarting the parallel application further comprises resuming execution of the processes organized into a group only after every process of the group restores the process's barrier operation state information from the previously saved checkpoint.

6. The method of claim 1 wherein exiting the checkpoint handler further comprises immediately resuming the parallel application.

7. The method of claim 1 wherein maintaining, by each computer processor, global barrier operation state information further comprises maintaining a hardware register designated for storing the global barrier operation state information, wherein each byte of the hardware register is associated with a separate process and represents that process's barrier operation state information.

8. A parallel computer for creating a checkpoint of a parallel application executing in the parallel computer, the parallel computer comprising a plurality of compute nodes, each compute node comprising one or more computer processors, the parallel application comprising a plurality of processes, one or more of the processes executing a barrier operation, the parallel computer further comprising a computer memory operatively coupled to one or more of the computer processors, the computer memory having disposed within it computer program instructions that, when executed by the computer processor, cause the parallel computer to carry out the steps of:
maintaining, by each computer processor in computer processor hardware, global barrier operation state information, the global barrier operation state information comprising an aggregation of each process's barrier operation state information;
invoking, for each process of the parallel application, a checkpoint handler;
saving, by each process's checkpoint handler as part of a checkpoint for the parallel application, the process's barrier operation state information; and
exiting, by each process, the checkpoint handler.

9. The parallel computer of claim 8 wherein:
maintaining global barrier operation state information further comprises initiating propagation of a change in one of the process's barrier operation state information amongst a plurality of computer processors in one of the compute nodes; and
invoking the checkpoint handler further comprises invoking the checkpoint handler prior to completing propagation amongst the plurality of computer processors in the compute node.

10. The parallel computer of claim 8 wherein exiting the checkpoint handler further comprises exiting the parallel application, and the parallel computer further comprises computer program instructions that, when executed by the computer processor, cause the parallel computer to carry out the steps of:
executing a second, different parallel application; and
upon completion of the second, different parallel application, restarting the previously exited parallel application, including:
invoking, for each process, a restart handler; and
restoring, by each process's restart handler from the previously saved checkpoint in a computer processor of a compute node, the process's barrier operation state information.

11. The parallel computer of claim 8 wherein exiting the checkpoint handler further comprises exiting the parallel application, and the parallel computer further comprises computer program instructions that, when executed by the computer processor, cause the parallel computer to carry out the steps of:
restarting the previously exited parallel application, including:
invoking, for each process, a restart handler; and
restoring, by each process's restart handler from the previously saved checkpoint in a computer processor of a compute node, the process's barrier operation state information.

12. The parallel computer of claim 11 wherein:
a subset of the parallel applications' processes are organized into a group; and
restarting the parallel application further comprises resuming execution of the processes organized into a group only after every process of the group restores the process's barrier operation state information from the previously saved checkpoint.

13. The parallel computer of claim 8 wherein exiting the checkpoint handler further comprises immediately resuming the parallel application.

14. The parallel computer of claim 8 wherein maintaining, by each computer processor, global barrier operation state information further comprises maintaining a hardware register designated for storing the global barrier operation state information, wherein each byte of the hardware register is associated with a separate process and represents that process's barrier operation state information.

15. A computer program product for creating a checkpoint of a parallel application executing in a parallel computer, the parallel computer comprising a plurality of compute nodes, each compute node comprising one or more computer processors, the parallel application comprising a plurality of processes, one or more of the processes executing a barrier operation, the computer program product disposed upon a computer readable medium, the computer program product comprising computer program instructions that, when executed, cause a computer to carry out the steps of:
maintaining, by each computer processor in computer processor hardware, global barrier operation state information, the global barrier operation state information comprising an aggregation of each process's barrier operation state information;
invoking, for each process of the parallel application, a checkpoint handler;
saving, by each process's checkpoint handler as part of a checkpoint for the parallel application, the process's barrier operation state information; and
exiting, by each process, the checkpoint handler.

16. The computer program product of claim 15 wherein:
maintaining global barrier operation state information further comprises initiating propagation of a change in one of the process's barrier operation state information amongst a plurality of computer processors in one of the compute nodes; and
invoking the checkpoint handler further comprises invoking the checkpoint handler prior to completing propagation amongst the plurality of computer processors in the compute node.

17. The computer program product of claim 15 wherein exiting the checkpoint handler further comprises exiting the parallel application, and the computer program product further comprises computer program instructions that, when executed, cause the computer to carry out the steps of:
executing a second, different parallel application; and
upon completion of the second, different parallel application, restarting the previously exited parallel application, including:
invoking, for each process, a restart handler; and
restoring, by each process's restart handler from the previously saved checkpoint in a computer processor of a compute node, the process's barrier operation state information.

18. The computer program product of claim 15 wherein exiting the checkpoint handler further comprises exiting the parallel application, and the computer program product further comprises computer program instructions that, when executed, cause the computer to carry out the steps of:
restarting the previously exited parallel application, including:
invoking, for each process, a restart handler; and
restoring, by each process's restart handler from the previously saved checkpoint in a computer processor of a compute node, the process's barrier operation state information.

19. The computer program product of claim 18 wherein:
a subset of the parallel applications' processes are organized into a group; and
restarting the parallel application further comprises resuming execution of the processes organized into a group only after every process of the group restores the process's barrier operation state information from the previously saved checkpoint.

20. The computer program product of claim 15 wherein exiting the checkpoint handler further comprises immediately resuming the parallel application.
